(19) United States
(12) Patent Application Publication
(10) Pub. No.: US 2025/0182367 A1
(43) Pub. Date: Jun. 5, 2025

(54) APPARATUS AND METHOD FOR REALISTIC MOVEMENT OF DIGITAL HUMAN CHARACTER

(71) Applicant: ELECTRONICS AND TELECOMMUNICATIONS RESEARCH INSTITUTE, Daejeon (KR)

(72) Inventors: Seung-Uk YOON, Daejeon (KR); Ki-Nam KIM, Daejeon (KR); Tae-Joon KIM, Sejong-si (KR); Seung-Wook LEE, Daejeon (KR); Seong-Jae LIM, Daejeon (KR); Bon-Woo HWANG, Daejeon (KR); Chang-Joon PARK, Daejeon (KR)

(73) Assignee: ELECTRONICS AND TELECOMMUNICATIONS RESEARCH INSTITUTE, Daejeon (KR)

(21) Appl. No.: 18/962,890

(22) Filed: Nov. 27, 2024

(30) Foreign Application Priority Data
Nov. 30, 2023 (KR) 10-2023-0170431
Oct. 11, 2024 (KR) 10-2024-0138679

(51) Int. Cl. G06T 13/40; G06T 7/194; G06T 15/00

(52) U.S. Cl. CPC G06T 13/40; G06T 7/194; G06T 15/00; G06T 2207/10016

(57) ABSTRACT

Disclosed herein is an apparatus and method for realistic movements of a digital human character. The apparatus includes memory in which at least one program is recorded and a processor for executing the program. The program performs generating a first video by realistically visualizing a video in which a 3D digital human character is rendered and generating a second video by making movements in the first video realistic based on a pretrained realization model, and the realization model may be pretrained based on a fourth video that is generated by converting a predetermined region of a live-action video of a person into a corresponding predetermined region of a third video obtained by realistically visualizing a video in which a 3D digital human character is rendered.

### CROSS REFERENCE TO RELATED APPLICATIONS

This application claims the benefit of Korean Patent Application No. 10-2023-0170431, filed Nov. 30, 2023, and No. 10-2024-0138679, filed Oct. 11, 2024, which are hereby incorporated by reference in their entireties into this application.

### BACKGROUND OF THE INVENTION

### 1. Technical Field

The disclosed embodiment relates to technology for improving awkward movements of digital human characters to natural movements.

### 2. Description of the Related Art

With the recent rise in popularity of the metaverse, interest in digital humans, one of key elements in the metaverse, is also increasing. A digital human in the metaverse plays the role of a virtual avatar of a user or the role of a counterpart that talks, reacts, and acts with the user. Although most existing digital human avatars based on 3D characters can be edited to some extent in the direction that a user wants, it is difficult to be immersed in these avatars due to low sense of reality or presence. With the recent development of real-time rendering technology, the quality of the character's appearance is increasing. However, high-quality digital human characters are mainly used in high-budget sectors, such as product showcases, movies, animations, and the like, due to heaviness of data and limitations in processing performance of terminals, and light digital human models that are simplified or embodied as characters are still used in casual metaverse applications.

Although quality varies depending on the production cost and application, the animation or movement of a digital human based on a 3D model is awkward. In the case of high-budget digital humans, a significant portion of the budget is spent on reducing awkwardness. However, the muscle structure of a 3D human model cannot exactly match that of a real person, and even with the help of equipment such as motion capture, the final movements are often modified by relying on the experience of professional designers. Various sensors and devices for face/body capture are being developed to transfer natural movements of actors to 3D digital human characters, but refining the captured data by correcting errors therein and modifying positions and lengths of joints by applying the refined data to 3D characters are time-consuming and costly tasks that require experts. With the recent development of AI technology, the use of AI technology for data refinement and motion retargeting is increasing, but a physical limit to the number of markers that can be attached and a physical difference between a motion capture actor and a 3D character may cause errors. In other words, errors at a motion capture stage, errors caused in a data refinement process, and errors in rigging and motion retargeting processes are accumulated, and animators check and modify movements of 3D characters in consideration of the accumulated errors. Accordingly, in metaverse applications in which low-cost digital humans are used, the movements of digital humans are highly limited. Even in applications in which high-cost digital humans are used (e.g., films, games, etc.), it is very challenging to reproduce realistic natural movements.

As solutions to this problem, various methods and techniques are being developed to improve performance and reduce errors at each stage of motion capture. Additionally, there are emerging methods in which, after taking the acting performance of a real person, the face is replaced with that of a 3D character or conversely, in which only a face in a 3D character animation is replaced with a real visual. However, partial replacement of a face region can increase awkwardness in a digital human due to mismatch between face and the remaining area.

### SUMMARY OF THE INVENTION

An object of the disclosed embodiment is to improve the awkward movements of a digital human character to natural movements.

An apparatus for realistic movements of a digital human character according to an embodiment includes memory in which at least one program is recorded and a processor for executing the program, and the program may perform generating a first video by realistically visualizing a video in which a 3D digital human character is rendered; and generating a second video by making movements in the first video realistic based on a pretrained realization model. The realization model may be pretrained based on a fourth video that is generated by converting a predetermined region of a live-action video of a person into a corresponding predetermined region of a third video obtained by realistically visualizing a video in which a 3D digital human character is rendered.

Here, the predetermined region may include at least one of a face, arms, legs, or a torso of a body, or a combination thereof.

Here, the fourth video may be generated by separating a background region and the predetermined region in the live-action video and replacing the separated predetermined region with the corresponding predetermined region of the third video.

A method for realistic movements of a digital human character according to an embodiment includes generating a first video by realistically visualizing a video in which a 3D digital human character is rendered; and generating a second video by making movements in the first video realistic based on a pretrained realization model, and the realization model may be pretrained based on a fourth video that is generated by converting a predetermined region of a live-action video of a person into a corresponding predetermined region of a third video obtained by realistically visualizing a video in which a 3D digital human character is rendered.

Here, the predetermined region may include at least one of a face, arms, legs, or a torso of a body, or a combination thereof.

Here, the fourth video may be generated by separating a background region and the predetermined region in the live-action video and replacing the separated predetermined region with the corresponding predetermined region of the third video.

An apparatus for generating a model for realistic movements of a digital human character according to an embodiment includes memory in which at least one program is recorded and a processor for executing the program, and the program may perform generating a first video by realistically visualizing a video in which a 3D digital human character is rendered, generating a second video by converting a predetermined region of a live-action video of a person into a corresponding predetermined region of the first video, and generating a realization model trained based on the first video and the second video.

Here, the predetermined region may include at least one of a face, arms, legs, or a torso of a body, or a combination thereof.

Here, generating the second video may include separating a background region and the predetermined region in the live-action video and replacing the separated predetermined region with the corresponding predetermined region of the first video.

Here, generating the realization model may comprise adjusting parameters of the realization model so as to minimize a difference between the second video and a value output from the realization model after inputting the first video thereto.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a schematic block diagram of an apparatus for realistic movements of a digital human character according to an embodiment;

FIG. 2 is a flowchart for explaining a method for generating a model for realistic movements of a digital human character according to an embodiment;

FIG. 3 is an exemplary view of realistic visualization of a rendered video according an embodiment;

FIG. 4 is an exemplary view of a live-action video of a person;

FIG. 5 is an exemplary view in which the face of a person in a live-action video is converted into a person face in a realistically visualized video;

FIG. 6 is a flowchart for explaining a method for realistic movements of a digital human character according to an embodiment;

FIG. 7 is an exemplary view of a digital human character whose movements are made realistic according to an embodiment; and

FIG. 8 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

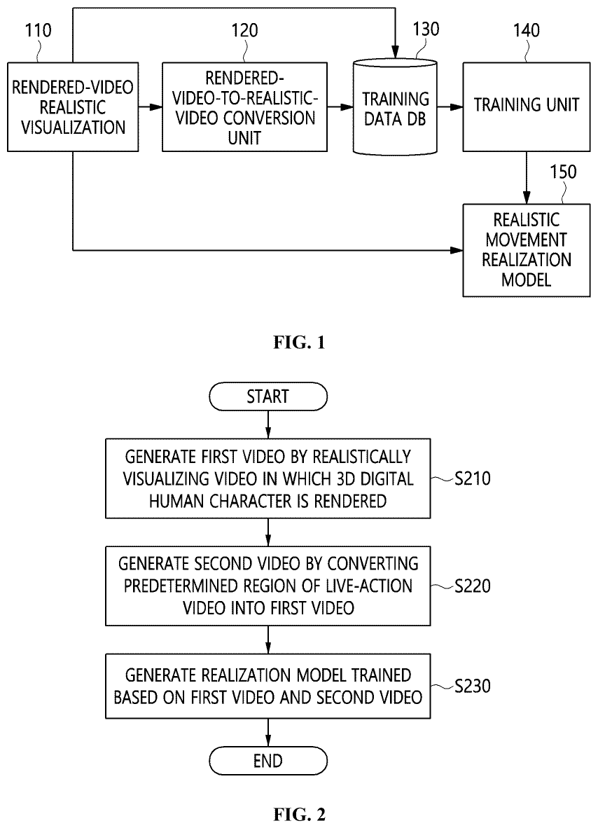

FIG. 1 is a schematic block diagram of an apparatus for realistic movements of a digital human character according to an embodiment.

Referring to FIG. 1, the apparatus for realistic movements of a digital human character according to an embodiment includes a rendered-video realistic visualization unit 110, a rendered-video-to-realistic-video conversion unit 120, a training data DB 130, a training unit 140, and a realistic movement realization model 150.

According to an embodiment, the rendered-video realistic visualization unit 110, the rendered-video-to-realistic-video conversion unit 120, the training data DB 130, and the training unit 140 may constitute an apparatus for generating a model for realistic movements of a digital human character. The detailed operation of the apparatus for generating a model for realistic movements of a digital human character according to an embodiment will be described later with reference to FIGS. 2 to 5.

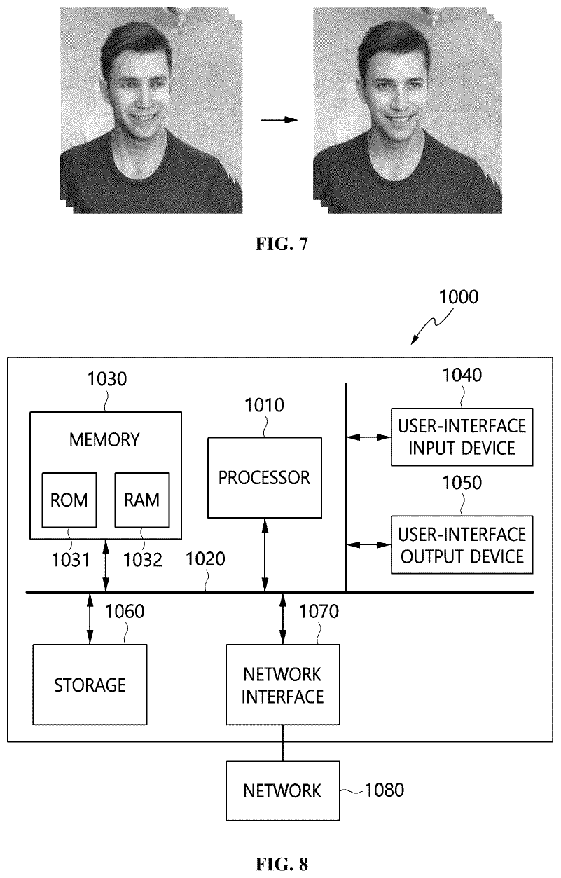

Also, the rendered-video realistic visualization unit 110 and the realistic movement realization model 150 according to an embodiment may constitute the apparatus for realistic movements of a digital human character. The detailed operation of the apparatus for realistic movements of a digital human character according to an embodiment will be described later with reference to FIGS. 6 to 7.

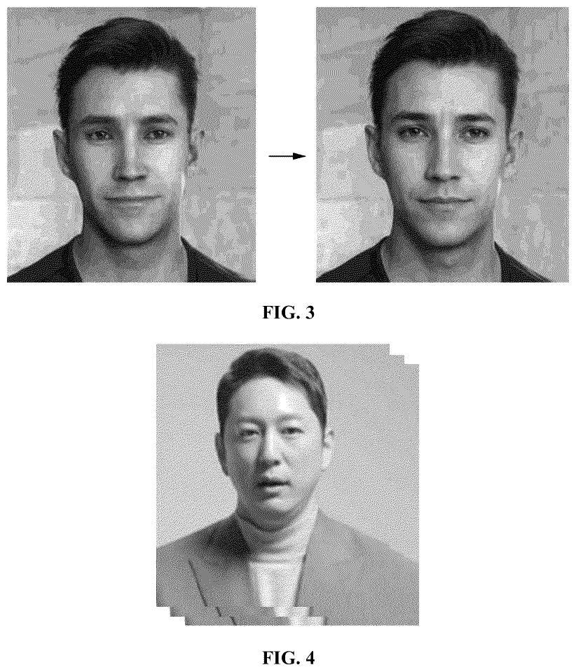

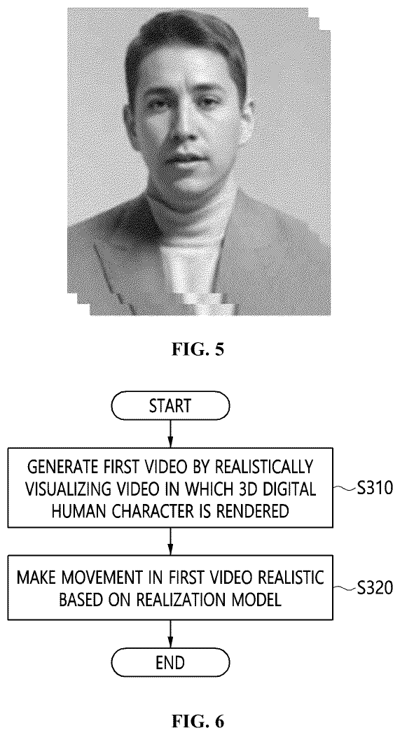

FIG. 2 is a flowchart for explaining a method for generating a model for realistic movements of a digital human character according to an embodiment, FIG. 3 is an exemplary view of realistic visualization of a rendered video according to an embodiment, FIG. 4 is an exemplary view of a live-action video of a person, and FIG. 5 is an exemplary view in which a person's face in a live-action video is converted into a person face of a realistically visualized video.

Referring to FIG. 2, the rendered-video realistic visualization unit 110 generates a first video at step S210 through realistic visualization of a video in which a 3D digital human character is rendered.

Here, realistic visualization refers to changing a 3D rendered character image to a realistic human image or recreating a 3D rendered character image as a realistic human image while maintaining the main identity of the character. As illustrated in FIG. 3, the character image on the left side may be recreated to look like a real person's image.

Realistic visualization may be performed using the technology disclosed in Korean Patent Application Publication No. 2021-0182514, titled “Method and apparatus for improving the quality and realism of rendered images”.

Here, realistic visualization makes only the appearance of a digital human lifelike, and movements follow the movements of the input character, so the unnaturalness is not cured.

Accordingly, the rendered-video-to-realistic-video conversion unit 120 generates a second video by converting a predetermined region of a live-action video of a person into a corresponding predetermined region of the first video at step S220.

That is, a person's face in the live-action video including talking or movements of a person, such as that illustrated in FIG. 4, is converted into the person's face of the realistically visualized image generated in FIG. 3.

Here, generating the second video at step S220 may include separating a background region and the predetermined region in the live-action video and replacing the separated predetermined region with the corresponding predetermined region of the first video.

To this end, a background part and a human part are separated in the live-action video frame using existing methods (V. Iglovikov and A. Shvets, TernausNet: U-Net with vgg11 encoder pre-trained on imagenet for image segmentation. arXiv preprint arXiv: 1801.05746, 2018), and when the part separation is completed, the face in the live-action video is replaced with the face of a realistically visualized image (I. Petrov, N. Chervoniy, J. Jian, S. Zhang, D. Gao, K. Liu, C. Ume, L. RP, P. Wu, and W. Zhang, DeepFaceLab: Integrated, flexible and extensible face-swapping framework, arXiv preprint arXiv: 2005.05535v5, 2021).

Although the above description is made by taking a face as an example of the predetermined region in order to help the understanding of the description, the present disclosure is not limited thereto.

That is, the predetermined region may include at least one of a face, arms, legs, or a torso of a body, or a combination thereof.

Through the above-described steps, the person in the live-action video is changed to a person obtained by realistically visualizing a 3D digital human, as illustrated in FIG. 5, but the facial expressions and movements follow the movements of the person in the live-action video. That is, the movements of the person whose face is replaced in the video are the same as the movements of the real person, so there is no characteristic awkwardness of the 3D character. By using this approach, the diverse live-action videos for the same person can be used to generate videos for a realistically visualized person's various movements.

The first and second videos generated as described above may be collected as the training data 130.

Accordingly, the training unit 140 may generate a realization model 150 trained based on the first and second videos stored as the training data at step S230.

Here, the training unit 140 may adjust the parameters of the realization model so as to minimize the difference between the second video and the value that is output from the realization model 150 after inputting the first video to the realization model 150.

The realization model 150 generated as described above may learn part separation and the correlation between frames, and the realization model 150 may be a model in which a realistically visualized digital human character performs natural movements of a real person.

FIG. 6 is a flowchart for explaining a method for realistic movements of a digital human character according to an embodiment, and FIG. 7 is an exemplary view in which movements of a digital human character are made realistic according to an embodiment.

Referring to FIG. 6, the rendered-video realistic visualization unit 110 generates a first video by realistically visualizing a video in which a 3D digital human character is rendered and outputs the first video at step S310.

The realistic movement realization model 150 makes movements in the first video, which is the realistically visualized digital human video such as that illustrated on the left side of FIG. 7, realistic, thereby generating natural movements that look like the movements of a real person, as shown in the second video on the right side.

Here, the realization model 150 may be pretrained based on a fourth video that is generated by converting a predetermined region of the live-action video of a person into a corresponding predetermined region of a third video obtained by realistically visualizing a video in which a 3D digital human character is rendered.

Here, the predetermined region may include at least one of a face, arms, legs, or a torso of a body, or a combination thereof.

Here, the fourth video may be generated by separating a background region and the predetermined region in the live-action video and replacing the separated predetermined region with the corresponding predetermined region of the third video.

An existing face-swapping or deepfake method is performed for a real image or a live-action video with the aim of replacing a face of a source with a face of a target. However, it is difficult to apply this method to a 3D rendered image or video of a non-real person, and the performance thereof is significantly degraded. Also, the method has the disadvantage of only being applicable to a face. However, it has an advantage in which there is no awkwardness in movements after the replacement of the face, because the target person copies the facial expressions of the source person.

In order to improve the awkward movements of a digital human, an embodiment proposes a new method in which natural movements of a real person are learned and applied to a realistically visualized digital human by replacing a real person with a realistically visualized digital human, rather than an approach for improving performance of each step of an existing 3D modeling and animation process. That is, this is a system to generate new training data based on a realistically visualized person in order to apply the naturalness of movements, which is an advantage that is imparted to the existing face-swapping method by learning and using data of a real person, to a 3D digital human. Also, the proposed method may also be applicable to a body, rather than being limited to a face, and is highly versatile because there is no limitation on face/swapping algorithms and the existing method is applicable. Particularly, the proposed method may improve movements of an already produced 3D digital human to look more natural, thereby helping in improving the quality of a digital human in various metaverse applications.

FIG. 8 is a view illustrating a computer system configuration according to an embodiment.

The apparatus for realistic movements of a digital human character and the apparatus for generating a model for realistic movements of a digital human character according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the disclosed embodiment, the movements of a digital human are naturally improved based on the rendered video of a 3D character.

According to the disclosed embodiment, it is possible to make the movements of a digital human realistic, which are difficult to solve with conventional pipelines for producing and rendering a 3D model at a high cost or with a method of replacing a face based on realistic images.

According to the disclosed embodiments, it is expected that the usability of a 3D digital human will be expanded and that realism will be improved in various real-time metaverse applications.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. An apparatus for realistic movements of a digital human character, comprising:
memory in which at least one program is recorded; and
a processor for executing the program,
wherein the program performs
generating a first video by realistically visualizing a video in which a 3D digital human character is rendered, and
generating a second video by making movements in the first video realistic based on a pretrained realization model,
wherein the realization model is pretrained based on a fourth video that is generated by converting a predetermined region of a live-action video of a person into a corresponding predetermined region of a third video obtained by realistically visualizing a video in which a 3D digital human character is rendered.

2. The apparatus of claim 1, wherein the predetermined region includes at least one of a face, arms, legs, or a torso of a body, or a combination thereof.

3. The apparatus of claim 1, wherein the fourth video is generated by separating a background region and the predetermined region in the live action video and replacing the separated predetermined region with the corresponding predetermined region of the third video.

4. A method for realistic movements of a digital human character, comprising:
generating a first video by realistically visualizing a video in which a 3D digital human character is rendered; and
generating a second video by making movements in the first video realistic based on a pretrained realization model,
wherein the realization model is pretrained based on a fourth video that is generated by converting a predetermined region of a live-action video of a person into a corresponding predetermined region of a third video obtained by realistically visualizing a video in which a 3D digital human character is rendered.

5. The method of claim 4, wherein the predetermined region includes at least one of a face, arms, legs, or a torso of a body, or a combination thereof.

6. The method of claim 4, wherein the fourth video is generated by separating a background region and the predetermined region in the live action video and replacing the separated predetermined region with the corresponding predetermined region of the third video.

7. An apparatus for generating a model for realistic movements of a digital human character, comprising:
memory in which at least one program is recorded; and
a processor for executing the program,
wherein the program performs
generating a first video by realistically visualizing a video in which a 3D digital human character is rendered,
generating a second video by converting a predetermined region of a live-action video of a person into a corresponding predetermined region of the first video, and
generating a realization model trained based on the first video and the second video.

8. The apparatus of claim 7, wherein the predetermined region includes at least one of a face, arms, legs, or a torso of a body, or a combination thereof.

9. The apparatus of claim 7, wherein generating the second video comprises
separating a background region and the predetermined region in the live-action video; and
replacing the separated predetermined region with the corresponding predetermined region of the first video.

10. The apparatus of claim 7, wherein generating the realization model comprises adjusting parameters of the realization model so as to minimize a difference between the second video and a value that is output from the realization model after inputting the first video to the realization model.
